(19) United States
(12) Patent Application Publication
(10) Pub. No.: US 2026/0241689 A1
(43) Pub. Date: Aug. 20, 2026

(54) LIQUID EJECTION HEAD

(71) Applicant: RISO Technologies Corporation, Tokyo (JP)

(72) Inventor: Sunao TAKENAKA, Mishima Shizuoka (JP)

(21) Appl. No.: 19/396,312

(22) Filed: Nov. 20, 2025

(30) Foreign Application Priority Data
Feb. 17, 2025 (JP) 2025-023779

(51) Int. Cl. B41J 2/14

(52) U.S. Cl. CPC B41J 2/14233; B41J 2/1433; B41J 2002/14306; B41J 2002/14419

(57) ABSTRACT

A liquid ejection head includes a nozzle plate extending in a first direction and having a nozzle for ejecting a liquid, and a plurality of flow path substrates extending in the first direction and each having an opening or a groove by which a pressure chamber communicating with the nozzle and a resistance flow path communicating with the pressure chamber are formed. At least one of the flow path substrates includes a first reinforcing wall portion at a location at which the pressure chamber is formed. In the first direction, a distance between one end of the first reinforcing wall portion that is closer to the nozzle than the other end and an edge of the nozzle that is closest to the one end of the first reinforcing wall portion is 75 μm to 175 μm.

### CROSS-REFERENCE TO RELATED APPLICATION

This application is based upon and claims the benefit of priority from Japanese Patent Application No. 2025-023779, filed on February 17, 2025, the entire contents of which are incorporated herein by reference.

### FIELD

Embodiments described herein relate generally to a liquid ejection head.

### BACKGROUND

In a liquid ejection head such as an inkjet head, a common method is to deform a vibration plate with an actuator made of a piezoelectric material, such as lead zirconate titanate (PZT). This deformation of the vibration plate deforms a pressure chamber facing it, causing ink to be ejected from a nozzle that communicates with the pressure chamber. The liquid ejection head includes a plurality of actuators bonded to the vibration plate, and a flow path portion that forms a plurality of pressure chambers facing the vibration plate and a flow path that communicates with the pressure chambers. In such an inkjet head, the flow path portion is formed by stacking a plurality of flow path substrates having slits of a predetermined shape. When a thin plate is used in the flow path portion to create viscous resistance for the ink, ensuring sufficient strength and maintaining positional accuracy during bonding become difficult.

### BRIEF DESCRIPTION OF THE DRAWINGS

FIG. 1 is a cross-sectional view illustrating an inkjet head according to a first embodiment.

FIG. 2 is a cross-sectional view illustrating the inkjet head.

FIG. 3 is a plan view illustrating a plurality of rows of a first flow path substrate.

FIG. 4 is a plan view illustrating one row of the first flow path substrate.

FIG. 5 is a plan view illustrating a plurality of rows of a second flow path substrate.

FIG. 6 is a plan view illustrating one row of the second flow path substrate.

FIG. 7 is a diagram illustrating a position of a reinforcing wall portion.

FIG. 8 is a diagram illustrating a relationship between a distance of the reinforcing wall portion from a nozzle and AL.

FIG. 9 is a diagram illustrating a relationship between a distance of the reinforcing wall portion from the nozzle, an ejection speed, and a droplet volume.

FIG. 10 is a diagram illustrating a distance of the reinforcing wall portion from the nozzle and variations in speed and volume between channels.

FIG. 11 is a diagram illustrating the position of the reinforcing wall portion.

FIG. 12 is a diagram illustrating a distance from one end portion of the reinforcing wall portion and the variations in speed and volume between the channels.

FIG. 13 is a diagram illustrating a position of a second reinforcing wall portion of an inkjet head according to another embodiment.

FIG. 14 is a diagram illustrating a distance of the reinforcing wall portion from a resistance flow path and variations in speed and volume between channels.

### DETAILED DESCRIPTION

Embodiments of this disclosure provide a liquid ejection head capable of ensuring the strength of a flow path portion and improving ejection performance.

In general, according to one embodiment, a liquid ejection head comprises a nozzle plate extending in a first direction and having a nozzle for ejecting a liquid; and a plurality of flow path substrates extending in the first direction and each having an opening or a groove by which a pressure chamber communicating with the nozzle and a resistance flow path communicating with the pressure chamber are formed. At least one of the flow path substrates includes a first reinforcing wall portion at a location at which the pressure chamber is formed. In the first direction, a distance between one end of the first reinforcing wall portion that is closer to the nozzle than the other end and an edge of the nozzle that is closest to the one end of the first reinforcing wall portion is 75 μm to 175 μm.

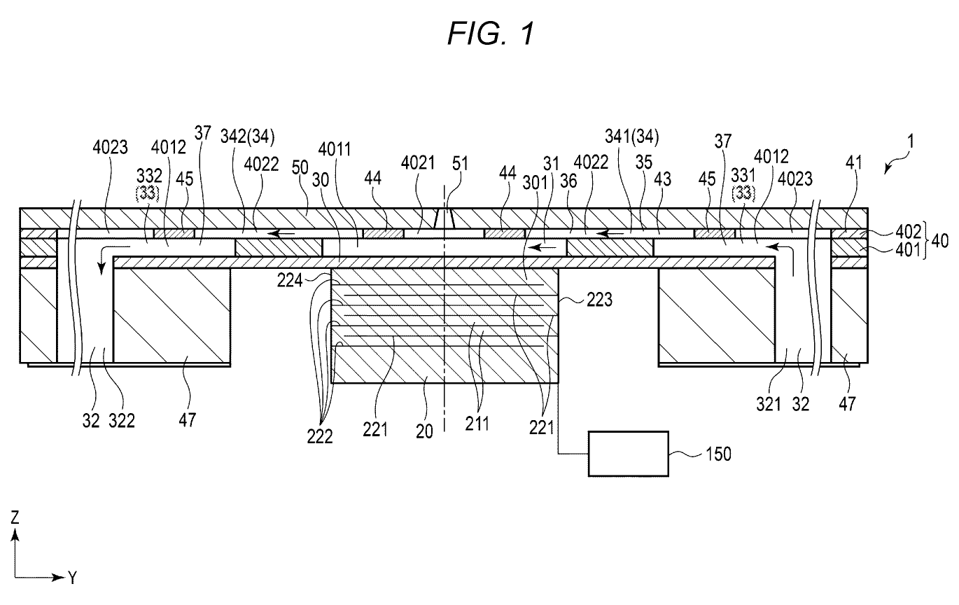

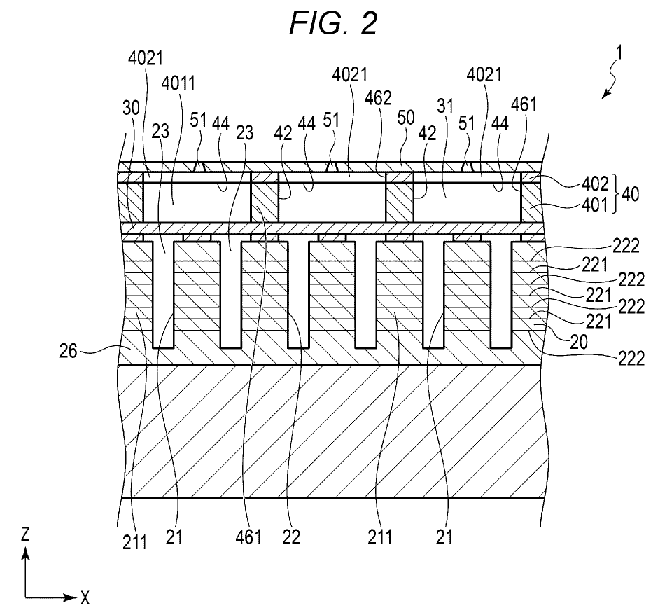

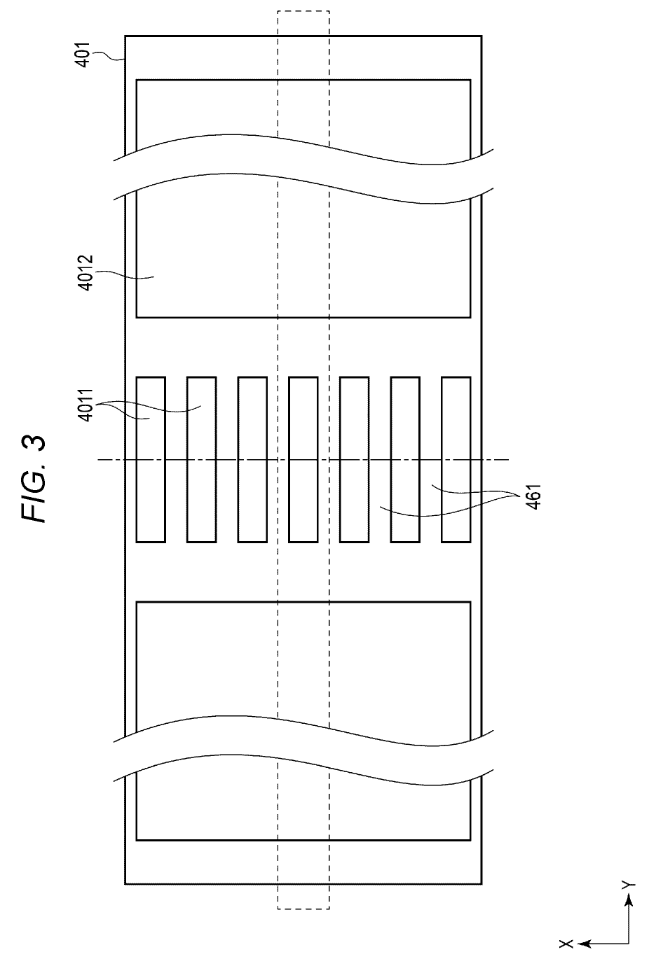

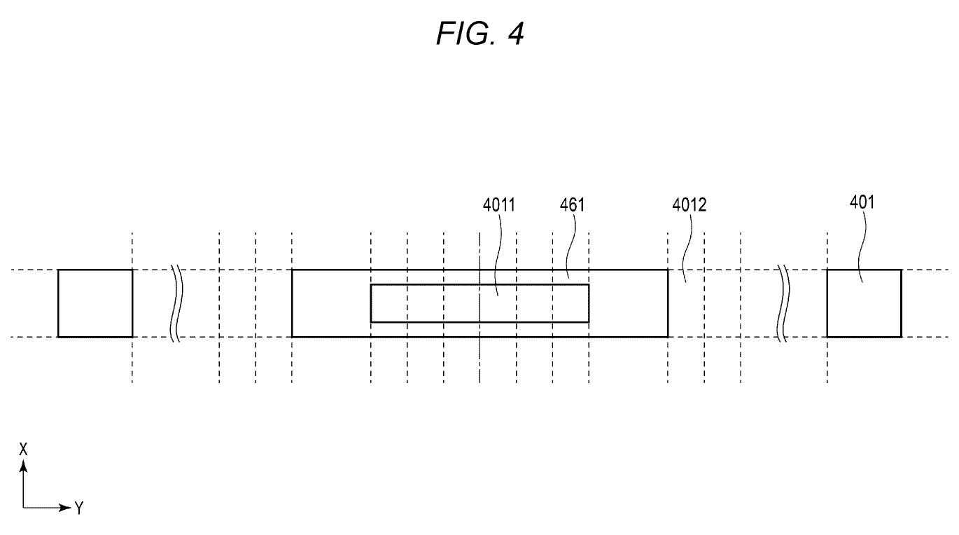

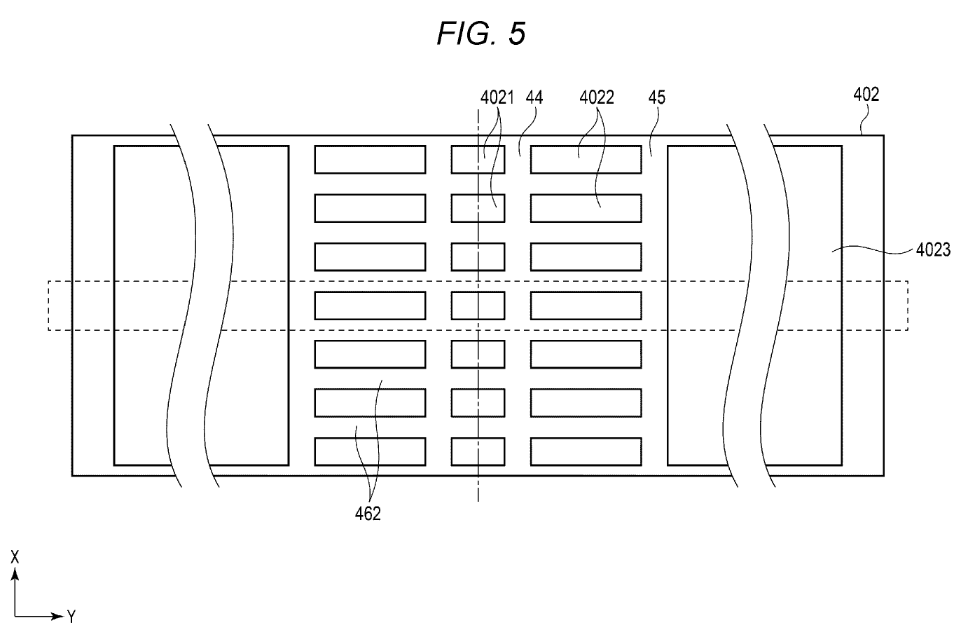

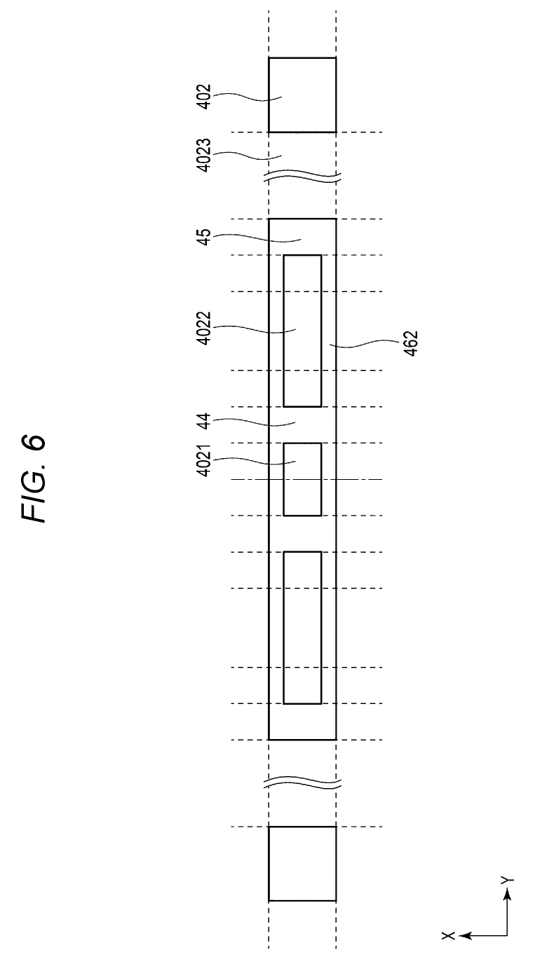

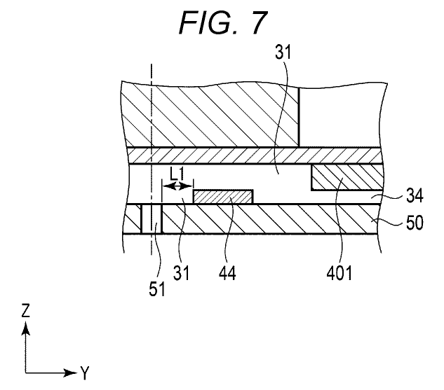

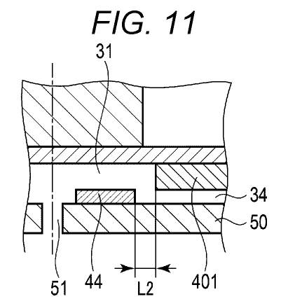

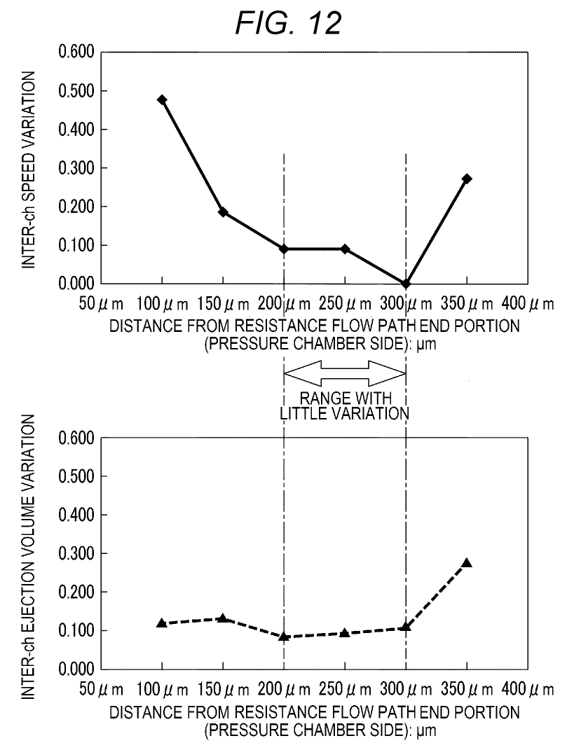

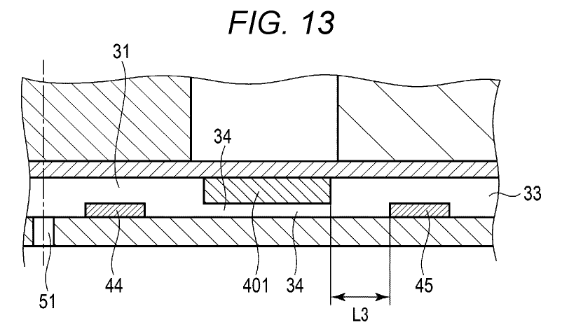

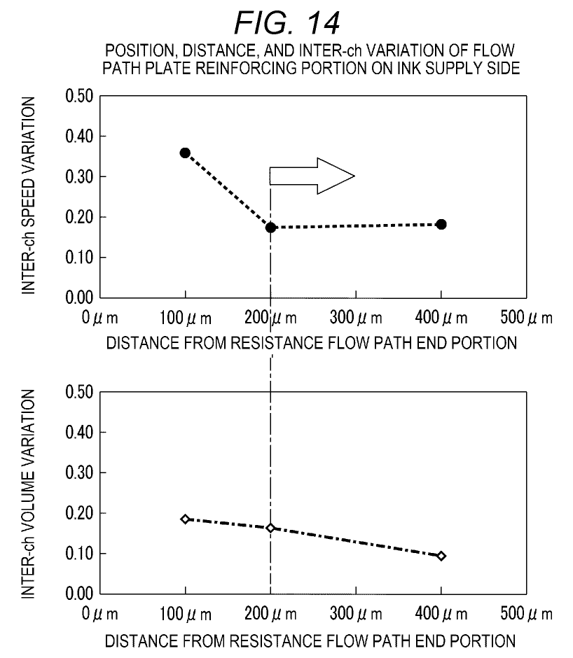

Hereinafter, an inkjet head 1 which is a liquid ejection head according to a first embodiment will be described with reference to FIGS. 1 to 14. FIG. 1 is a cross-sectional view illustrating the inkjet head 1 according to the first embodiment, and FIG. 2 is a cross-sectional view illustrating the inkjet head 1. FIG. 3 is a plan view of a plurality of rows of a first flow path substrate of the inkjet head 1, and FIG. 4 is a plan view illustrating one row of the first flow path substrate. FIG. 5 is a plan view of a plurality of rows of a second flow path substrate, and FIG. 6 is a plan view illustrating one row of the second flow path substrate. FIGS. 7 to 10 are diagrams illustrating characteristics of a distance of the first reinforcing wall portion of the second flow path substrate from the nozzle, AL, an ejection speed, and an ejection volume. FIGS. 11 and 12 are diagrams illustrating characteristics of a distance between the first reinforcing wall portion of the second flow path substrate and one end portion which is an end portion on a nozzle side of a resistance flow path, the ejection speed, and the ejection volume. FIGS. 13 and 14 are diagrams illustrating characteristics of a distance of the second reinforcing wall portion of the second flow path substrate from the resistance flow path, the ejection speed, and the ejection volume. In the drawings, arrows X, Y, and Z indicate three directions orthogonal to one another. In the present embodiment, the X direction is the direction in which nozzles 51 and pressure chambers 31 are arranged in parallel, the Y direction is the extending direction, and the Z direction is the axial direction of the nozzles. In the drawings, a configuration is illustrated enlarged, reduced, or omitted as appropriate for the purpose of description.

As illustrated in FIGS. 1 and 2, the inkjet head 1 includes an actuator portion 20, a vibration plate 30, a flow path member 40 as a flow path portion having a plurality of flow path substrates 401 and 402, a nozzle plate 50 as a nozzle portion having a plurality of nozzles 51, and a manifold 47 as a structure portion. For example, in the inkjet head 1 according to the present embodiment, a stacking direction of piezoelectric layers 211, a vibration direction of a piezoelectric element 21, and a vibration direction of the vibration plate 30 are along the Z direction. In the present embodiment, on a back side of the nozzle plate 50, the vibration plate 30 and the flow path member 40 constitute a flow path structure portion that forms an ink flow path 35 in the head 1. The inkjet head 1 is, for example, a circulation type in which liquid is circulated in a predetermined flow path including a pressure chamber. The inkjet head 1 is provided in a liquid ejection apparatus such as an inkjet recording apparatus.

For example, the inkjet head 1 is a side-shooter type four-row integrated structure head having two sets of head main bodies each having a pair of actuator portions 20. That is, in the inkjet head 1, four nozzle rows in which the plurality of nozzles 51 are arranged in parallel are formed.

The actuator portion 20 is formed of, for example, a piezoelectric member, and includes a plurality of drive piezoelectric elements 21 and a plurality of non-drive piezoelectric elements 22 serving as actuators alternately arranged along a row direction, and a piezoelectric structure portion 26 that integrally couples the plurality of piezoelectric elements 21 and 22. In the present embodiment, the nozzle 51 is provided at the center in an extending direction of the actuator portion 20, and the actuator portion 20 has a structure in which one side and the other side are symmetrical with respect to the nozzle 51. For example, the actuator portion 20 is bonded to a rectangular base.

In the actuator portion 20, the plurality of drive piezoelectric elements 21 and the plurality of non-drive piezoelectric elements 22 are arranged in parallel at regular intervals. For example, the plurality of drive piezoelectric elements 21 and the plurality of non-drive piezoelectric elements 22 are formed in rectangular columnar shapes having the same outer shape. The actuator portion 20 is divided into a plurality of portions by a plurality of grooves 23, and the plurality of drive piezoelectric elements 21 and the plurality of non-drive piezoelectric elements 22 are formed side by side in the row direction at the same pitch.

For example, the plurality of drive piezoelectric elements 21 and the plurality of non-drive piezoelectric elements 22 are formed in a rectangular shape having a short side direction along the row direction of an element row and a longitudinal direction along an extending direction that is orthogonal to the row direction and the Z direction in a plan view as viewed from the Z direction which is an axial direction of the nozzle 51.

The drive piezoelectric elements 21 are arranged at positions facing the plurality of pressure chambers 31 formed in the flow path member 40 in the Z direction. For example, a center position of the drive piezoelectric element 21 in the row direction and the extending direction and a center position of the pressure chamber 31 in the row direction and the extending direction are aligned in the Z direction.

The non-drive piezoelectric elements 22 are arranged at positions facing partition wall portions 42 formed in the flow path member 40 in the Z direction. For example, a center position of the non-drive piezoelectric element 22 in the row direction and the extending direction and a center position of the partition wall portion 42 in the row direction and the extending direction are aligned in the Z direction.

For example, stacked piezoelectric members constituting the actuator portion 20 are formed by stacking and sintering sheet-shaped piezoelectric materials. In the actuator portion 20, a plurality of piezoelectric elements formed in rectangular columnar shapes are formed at predetermined intervals by forming the grooves 23 by die-working the stacked piezoelectric members from one end surface. Electrodes and the like are provided on a plurality of the formed columnar elements to form the plurality of drive piezoelectric elements 21 and the plurality of non-drive piezoelectric elements 22 that are arranged alternately. The plurality of drive piezoelectric elements 21 and the plurality of non-drive piezoelectric elements 22 are alternately arranged in parallel in a manner of sandwiching the grooves 23 in the row direction.

Piezoelectric members including the drive piezoelectric elements 21 and the non-drive piezoelectric elements 22 are, for example, stacked piezoelectric bodies. Each of the drive piezoelectric elements 21 and the non-drive piezoelectric elements 22 includes a plurality of stacked piezoelectric layers 211 and internal electrodes 221 and 222 formed on a surface of each of the piezoelectric layers 211. For example, the drive piezoelectric elements 21 and the non-drive piezoelectric elements 22 have the same stacked structure. Each of the drive piezoelectric elements 21 and the non-drive piezoelectric elements 22 includes external electrodes 223 and 224 formed on surfaces of the piezoelectric element.

The piezoelectric layer 211 is formed of a piezoelectric material such as a lead zirconate titanate (PZT) based material or a lead-free sodium potassium niobate (KNN) based material. The plurality of piezoelectric layers 211 are stacked in a thickness direction along the stacking direction. For example, in the present embodiment, the thickness direction and the stacking direction of the piezoelectric layers 211 are disposed along the vibration direction (Z direction).

The internal electrodes 221 and 222 are conductive films formed in a predetermined shape and formed of a sinterable conductive material such as silver palladium. The internal electrodes 221 and 222 are formed in predetermined regions on the main surfaces of the piezoelectric layers 211. The internal electrodes 221 and 222 have different poles. For example, the internal electrode 221 is formed in a region reaching one end portion of the piezoelectric layer 211 and not reaching the other end portion of the piezoelectric layer 211 in the extending direction (Y direction) orthogonal to both the vibration direction (Z direction) and the row direction (X direction) which is an arrangement direction of the plurality of drive piezoelectric elements 21 and the plurality of non-drive piezoelectric elements 22. The other internal electrode 222 is formed in a region not reaching one end portion of the piezoelectric layer 211 but reaching the other end portion of the piezoelectric layer 211 in the extending direction. The internal electrodes 221 and 222 are connected to the external electrodes 223 and 224 formed on the side surfaces of the piezoelectric elements 21 and 22, respectively.

The stacked piezoelectric members including the drive piezoelectric elements 21 and the non-drive piezoelectric elements 22 may further include dummy layers on either one or both of a side close to the nozzle plate 50 and an end portion on an opposite side. The dummy layer is formed of, for example, the same material as the piezoelectric layer 211, includes an electrode only on one side, and is not deformed because no electric field is applied thereto. For example, the dummy layer does not function as a piezoelectric body, but serves to fix the actuator portion 20 to a base, or serves as a polishing allowance for polishing to improve accuracy during and after assembly.

The external electrodes 223 and 224 are formed on surfaces of the plurality of drive piezoelectric elements 21 and the plurality of non-drive piezoelectric elements 22, and are formed by collecting end portions of the internal electrodes 221 and 222. For example, the external electrodes 223 and 224 are respectively formed on one end surface and the other end surface in the extending direction of the piezoelectric layer 211. The external electrodes 223 and 224 are formed of Ni, Cr, Au, or the like by a known method such as plating or sputtering. The external electrode 223 and the external electrode 224 have different poles. The external electrode 223 and the external electrode 224 are respectively disposed on different side surface portions of the plurality of drive piezoelectric elements 21 and the plurality of non-drive piezoelectric elements 22. The external electrodes 223 and 224 may be disposed in different regions on the same side surface portions of the plurality of drive piezoelectric elements 21 and the plurality of non-drive piezoelectric elements 22.

In the present embodiment, for example, the external electrodes 223 are individual electrodes, and the external electrodes 224 are common electrodes. Electrode layers of the external electrodes 223 serving as individual electrodes of the plurality of drive piezoelectric elements 21 and the plurality of non-drive piezoelectric elements 22 are divided by the grooves 23, and are disposed independently of one another. Electrode layers of the external electrodes 224 serving as the common electrodes are connected to one another, for example, on a side surface of the piezoelectric structure portion 26, and, for example, are grounded. The external electrodes 223 and 224 are connected to a drive circuit via, for example, a wiring film. For example, each of the external electrodes 223 and 224 is connected to a control unit 150 via a drive circuit and is implemented to be driven and controlled. The arrangement of the common electrode and the individual electrode may be reversed.

The vibration direction of the piezoelectric elements 21 and 22 is along the stacking direction, and the piezoelectric elements 21 and 22 are displaced in a d33 direction when an electric field is applied. The number of piezoelectric layers 211 of each of the piezoelectric elements 21 and 22 is 3 or more and 50 or less, a thickness of each layer is 10 μm or more and 40 μm or less, and the product of the thickness and the total number of layers is less than 1000 μm.

In the inkjet head 1, the drive piezoelectric element 21 vibrates when a voltage is applied to the internal electrodes 221 and 222 via the external electrodes 223 and 224. In the present embodiment, the drive piezoelectric elements 21 perform longitudinal vibration along the stacking direction of the piezoelectric layers 211. The term "longitudinal vibration" referred to here is, for example, "vibration in a thickness direction defined by a piezoelectric constant d33". The drive piezoelectric element 21 displaces the vibration plate 30 and deforms the pressure chamber 31 by the longitudinal vibration.

The vibration plate 30 extends along a plane orthogonal to the Z direction which is the vibration direction, and is bonded to one side in the vibration direction of the piezoelectric layers 211 of the plurality of piezoelectric elements 21 and 22, that is, a surface on a side close to the nozzle plate 50. The vibration plate 30 faces the plurality of nozzles 51 via the pressure chambers 31 in the Z direction which is the vibration direction. For example, the vibration plate 30 is deformable and bonded to the drive piezoelectric element 21 and the non-drive piezoelectric element 22 of the actuator portion 20 and the manifold 47. For example, the vibration plate 30 has a vibration region 301 facing the piezoelectric elements 21 and 22 and a support region facing the manifold 47. The vibration plate 30 is provided between the flow path substrate 401 and the actuator portion 20 in the vibration direction. The vibration plate 30 is disposed to overlap the plurality of flow path substrates 401 and 402, and constitutes a part of the ink flow path 35.

The vibration region 301 has, for example, a flat plate shape disposed such that the thickness direction is the vibration direction of the piezoelectric layer 211. The plane direction of the vibration plate 30 extends in the arrangement direction of the plurality of drive piezoelectric elements 21 and the plurality of non-drive piezoelectric elements 22. The vibration plate 30 is, for example, a metal plate. The vibration plate 30 has a plurality of vibration portions that face the respective pressure chambers 31 and can be displaced individually. The vibration plate 30 is formed by integrally coupling the plurality of vibration portions.

For example, the vibration plate 30 is formed of a nickel plate or an SUS plate, and the thickness dimension thereof along the vibration direction is about 5 μm to 15 μm. In the vibration region 301, a fold or a step may be formed at a portion adjacent to the vibration portion or between adjacent vibration portions so that the plurality of vibration portions are easily displaced. The vibration region 301 is deformed by displacing a portion that faces the drive piezoelectric element 21 due to expansion and compression of the drive piezoelectric element 21. For example, since the vibration plate 30 needs to have a very thin and complicated shape, the vibration plate 30 is formed by electroforming or the like. The vibration plate 30 is bonded to an upper end surface of the actuator portion 20 by adhesion or the like.

The support region where the vibration plate 30 faces the manifold 47 is a plate-shaped member disposed between the manifold 47 and the flow path substrate 401. The vibration plate 30 has a structure in which one side and the other side in the Y direction are symmetrical with respect to the nozzle 51.

The flow path member 40 is bonded to one side of the vibration plate 30.

As illustrated in FIGS. 1 to 6, the flow path member 40 includes a plurality of flow path substrates 401 and 402 that are stacked. For example, the flow path member 40 includes the flow path substrate 401 as a first flow path substrate and the flow path substrate 402 as a second flow path substrate which are stacked. For example, the plurality of flow path substrates 401 and 402, the nozzle plate 50, and the vibration plate 30, each of which has an opening or a groove, are combined and bonded to form the desired ink flow path 35 according to ink viscosity, a volume of the ink to be ejected, and the like. The plurality of flow path substrates 401 and 402 are disposed to overlap each other in the stacking direction, and constitute the ink flow path 35 including the pressure chamber 31 communicating with the plurality of nozzles 51, a resistance flow path 341 which is a first individual flow path, a resistance flow path 342 which is a second individual flow path, a first common flow path portion 331, and a second common flow path portion 332 by openings or grooves formed in each of the flow path substrates 401 and 402. For example, the flow path substrates 401 and 402 are stacked in order from a vibration plate 30 side, and the flow path substrate 402 is disposed to face the nozzle plate 50. For example, in the present embodiment, the resistance flow path 341 on one side which is the first individual flow path, the pressure chamber 31, and the resistance flow path 342 on the other side which is the second individual flow path are arranged side by side along the Y direction corresponding to each of the plurality of nozzles 51, and a plurality of individual liquid chambers 36 extending in the Y direction are formed. The first common flow path portion 331 and the second common flow path portion 332 extend in a first direction on both sides in the Y direction of the plurality of individual liquid chambers 36 arranged in the first direction.

The flow path member 40 is disposed between the nozzle plate 50 and the vibration plate 30. The flow path member 40 is formed by stacking and bonding the plurality of flow path substrates 401 and 402 to form the predetermined ink flow path 35 (liquid chamber) including, therein, the plurality of pressure chambers 31, the common flow path portions 331 and 332 that communicate with a common chamber 32, and the plurality of resistance flow paths 341 and 342 (throttle portion) extending from the common flow path portions 331 and 332 to the pressure chambers 31. In other words, the flow path member 40 is formed by the plurality of stacked flow path substrates 401 and 402, and includes a peripheral wall portion 41 that surrounds the ink flow path 35 (liquid chamber) including the plurality of pressure chambers 31, the plurality of resistance flow paths 341 and 342, and the common flow path portions 331 and 332, and includes the plurality of the partition wall portions 42 that partition rows of the plurality of pressure chambers 31, and side wall portions 43 that partition the plurality of resistance flow paths 341 and 342. For example, the flow path member 40 includes a plurality of rows of ink flow paths 35 corresponding to the number of nozzles, and in FIGS. 3 and 5, a region corresponding to seven rows of pressure chambers 31 (channels) is illustrated, and in FIGS. 4 and 6, only a region corresponding to one row is illustrated.

That is, the common flow path portion 33 (the upstream common flow path portion 331 and the downstream common flow path portion 332) is formed in a plurality of rows, and each of the common flow path portions 33 extends along a direction in which the nozzles 51 are arranged in parallel (X direction) which is orthogonal to the extending direction (Y direction) in which the resistance flow paths 341 and 342 and the pressure chambers 31 are arranged.

The flow path substrate 401 which is the first flow path substrate is bonded to the vibration plate 30. The flow path substrate 401 is a plate-shaped member having the same outer shape as the vibration plate 30, and is made of, for example, a metal material including SUS 430 or a resin material such as silicone. The flow path substrate 401 has first openings 4011 each forming a part of the pressure chamber 31 and second openings 4012 each forming a part of the common flow path portions 331 and 332. For example, the first opening 4011 is disposed at the center in the extending direction in which the ink flow path 35 extends, and the second openings 4012 are disposed at both ends. The first openings 4011 forming the pressure chambers 31 are partitioned into a plurality of rows in the X direction, and beam-shaped portions 461 are formed between the openings 4011 adjacent to each other in the arrangement direction. Meanwhile, the openings 4012 forming the common flow path portions 331 and 332 are connected in a plurality of rows, and form an opening shape having a length in the X direction larger than that of the first openings 4011. The openings 4012 are divided into, for example, seven rows.

The flow path substrate 402, which is the second flow path substrate, is stacked on the flow path substrate 401 and bonded to the flow path substrate 401. The flow path substrate 402 is a plate-shaped member having the same outer shape as the vibration plate 30, and is made of, for example, a metal material including SUS 430 or a resin material such as silicone. The resistance flow paths 341 and 342 which are individual flow paths are formed in the flow path substrate 402. The flow path substrate 402 has a plurality of openings 4021, 4022, and 4023 arranged along one direction via the reinforcing wall portions 44 and 45.

The plurality of openings 4021, 4022, and 4023 form openings penetrating in the thickness direction. The plurality of openings 4021 and 4022 are arranged side by side in one direction via the reinforcing wall portions 44 and 45. The flow path substrate 402 is a substrate in which an opening is formed in the longest range in the extending direction among the plurality of flow path substrates 401 and 402. In addition, for example, the openings 4021 and 4022 of the flow path substrate 402 have a smaller width dimension than the opening 4011 formed in the other substrate 401. The thickness of the plurality of flow path substrates 401 and 402 is set according to conditions such as resistance and a flow rate, but in the example illustrated in FIG. 1, the flow path substrate 402 in which the resistance flow paths 341 and 342 having a small cross-sectional area are formed is implemented to be thinner than the thickness of the other first flow path substrate 401.

The openings 4021 and 4022 are formed by slit-shaped rectangular openings that are long in the Y direction, are arranged in a plurality of rows in the arrangement direction, and the beam-shaped portions 462 are formed between the plurality of openings 4021 adjacent in the arrangement direction or between the plurality of openings 4022.

For example, the first openings 4021 are disposed at the center in the extending direction in which the ink flow path 35 extends, the second openings 4022 are disposed at both ends via the first reinforcing wall portions 44, and the third openings 4023 are disposed at the other end portions of the second openings 4022 on both sides opposite to the nozzles 51 via second reinforcing wall portions 45. The first opening 4021 forming the pressure chamber 31 and the second opening 4022 forming the resistance flow paths 341 and 342 are partitioned into a plurality of rows in the X direction, and the beam-shaped portion 462 is formed between the openings 4021 adjacent to each other in the arrangement direction or between the openings 4022. Meanwhile, the openings 4023 forming the common flow path portions 331 and 332 are connected in a plurality of rows, and form an opening shape having a length in the X direction larger than that of the first openings 4021 and 4022. The openings 4023 are divided into, for example, seven rows.

For example, the reinforcing wall portions 44 and 45 are wall-shaped members that connect the beam-shaped portions 462 on both sides of the openings 4021 and 4022 in the width direction, and in other words, a slit-shaped opening long in one direction of the second flow path substrate 402 is partially closed and divided by the reinforcing wall portions 44 and 45.

The first reinforcing wall portion 44 (wall portion) is formed in a region that overlaps the opening 4011 of the substrate 401 facing the first reinforcing wall portion 44 and does not block the nozzle 51. In the present embodiment, the first reinforcing wall portion 44 is formed on each of one side and the other side of the nozzle 51 in the pressure chamber 31. For example, the reinforcing wall portion 44 is disposed at a portion between an inlet and outlet of the pressure chamber 31, which is a portion where the pressure chamber 31 communicates with the resistance flow paths 341 and 342, and the nozzle 51. In addition, the reinforcing wall portion 44 does not overlap the nozzle 51 and is disposed at a position which is separated from the nozzle 51 by a predetermined distance or more and does not block the nozzle 51.

That is, the first reinforcing wall portion 44 is a connecting wall portion that is formed in the pressure chamber 31 and extends between the beam-shaped portions 462 in the X direction to connect the beam-shaped portions 462 between the elongated slit rows formed by the openings 4021 and 4022 arranged in one direction.

The second reinforcing wall portions 45 are provided at positions facing the common flow path portions 331 and 332. The reinforcing wall portion 45 is provided at a position upstream of an inlet of the resistance flow path 341 and at a position downstream of an outlet of the downstream resistance flow path 342. The second reinforcing wall portions 45 are formed in the common flow path portions 331 and 332, and each is a connecting wall portion that connects the beam-shaped portions 462 by extending between the beam-shaped portions 462 in the X direction between a plurality of rows of elongated slit-shaped openings 4022 and the plurality of rows of wide openings 4023.

For example, the thickness of the reinforcing wall portions 44 and 45 in the stacking direction is the same as the thickness of the flow path substrate 402 in the stacking direction. Therefore, the reinforcing wall portions have the same height as the height of the resistance flow paths 341 and 342.

The reinforcing wall portions 44 and 45 are formed, for example, by etching except for portions to be the reinforcing wall portions 44 and 45 when the openings 4021 to 4023 are formed. The reinforcing wall portions 44 and 45 serve as support members that support the beam-shaped portions 462 of the flow path substrate 402 by connecting the plurality of beam-shaped portions 462. That is, the flow path substrate 402 which is the second flow path substrate is formed with the longest flow path and has the reinforcing wall portions 44 and 45 as the reinforcing wall portions.

The arrangement of the reinforcing wall portions 44 and 45 is set at a position where the influence on ejection performance of the inkjet head 1 is small. In the present embodiment, the first reinforcing wall portion 44 in the pressure chamber 31 is disposed at a position where a distance L1 from an edge of the nozzle 51 is equal to or greater than 75 μm. For example, a position of one end portion of the reinforcing wall portion 44 in the pressure chamber 31 is provided in a range of 75 μm to 175 μm from the edge of the nozzle 51.

Meanwhile, the second reinforcing wall portion 45 provided on the side opposite to the pressure chamber 31 with respect to the resistance flow path 34 (the upstream resistance flow path 341 and the downstream resistance flow path 342) is disposed at a position where a distance L3 from the other end portion of the resistance flow path 34 is 200 μm or more.

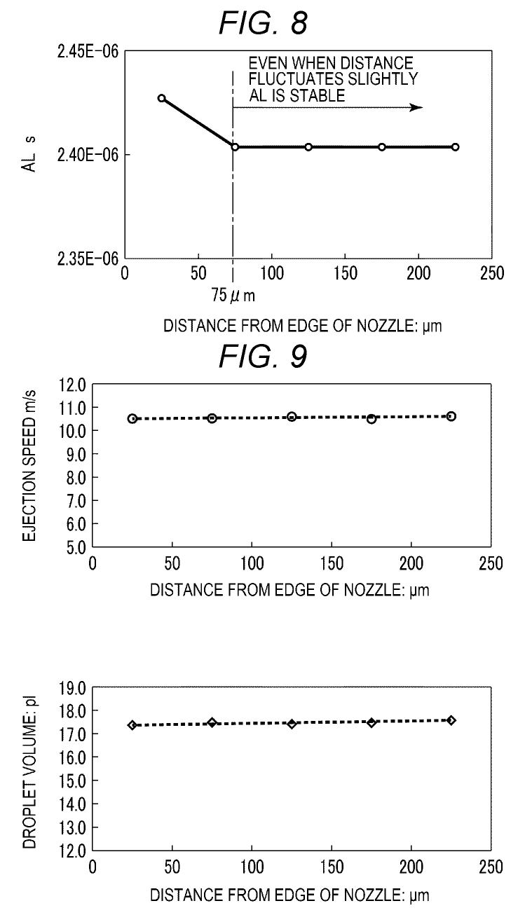

Here, FIG. 7 is a diagram illustrating the arrangement of the first reinforcing wall portion 44, and FIG. 8 is a graph illustrating a relationship between the distance L1 from one end portion of the first reinforcing wall portion 44 to the edge of the nozzle 51 and AL (acoustic length) which is half the natural vibration period determined by shapes of the nozzle and the flow path and ink physical properties.

FIG. 8 illustrates that stable AL is obtained when the distance of the reinforcing wall portion 44 from the edge of the nozzle 51 is 75 μm or more. That is, since the stable AL can be obtained even when the position of the reinforcing wall portion 44 slightly varies, it is illustrated that the distance of the reinforcing wall portion 44 from the edge of the nozzle 51 is preferably 75 μm or more.

In addition, in the case of single nozzle driving, an ejection speed and a droplet volume are not significantly affected by the position of the reinforcing wall portion 44 of the flow path substrate 402, but when the nozzles 51 of a plurality of channels are driven, it is conceivable that inter-channel variation in the ejection speed and the droplet volume occurs depending on the position of the reinforcing wall portion 44.

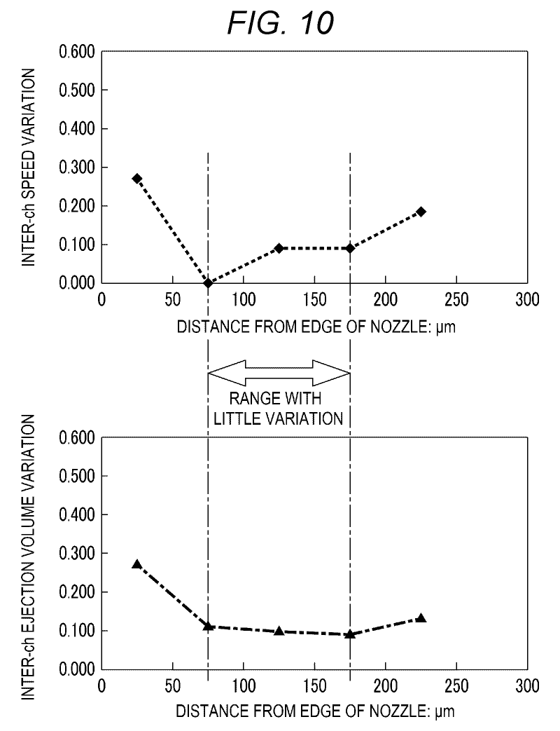

FIG. 10 illustrates a relationship between the distance L1 from the edge of the nozzle to one end portion of the reinforcing wall portion and an inter-channel variation in ejection speed and droplet volume. In FIG. 10, the variation is calculated by a maximum to minimum difference.

According to FIG. 10, it can be seen that when the distance L1 from the edge of the nozzle 51 to the position of the reinforcing wall portion 44 in the pressure chamber 31 is set to 75 μm to 175 μm, both the variation in the ejection speed and the variation in the droplet volume between channels are reduced. Therefore, in the present embodiment, the position of the reinforcing wall portion 44 in the pressure chamber 31 is set to a position of about 75 μm to 175 μm from the edge of the nozzle 51.

In addition, it is preferable that the position of the reinforcing wall portion 44 is appropriately separated by a distance L2 (FIG. 11) between the reinforcing wall portion 44 and one end portion of the resistance flow path 34 on a pressure chamber side. FIG. 12 illustrates a relationship between the distance L2 from one end portion of the resistance flow path 34 on the pressure chamber side to the reinforcing wall portion 44 and an inter-channel variation of each of the ejection speed and the droplet volume.

According to FIG. 12, it can be seen that when the distance L2 between one end portion of the resistance flow path 34 on a side connected to the pressure chamber 31 and the other end portion of the first reinforcing wall portion 44 on a side opposite to the nozzle 51 side is set to about 200 μm to 300 μm, the variation between the pressure chambers (channels) is reduced for each of the ejection speed and the droplet volume. Therefore, in the present embodiment, the distance L2 between the other end portion of the reinforcing wall portion 44 on a resistance flow path side and one end portion of the resistance flow path 341 in the extending direction, that is, a boundary portion between the resistance flow path 34 and the pressure chamber 31 is set to a position separated by 200 μm or more.

From the above, when the reinforcing wall portion 44 of the flow path substrate 402 that determines the height of the resistance flow path is provided in the pressure chamber 31, the position thereof should not be too close to the nozzle 51 or too close to the resistance flow path 34, and the position of the reinforcing wall portion 44 in the pressure chamber 31 is set such that the distance L1 from the edge of the nozzle 51 is 75 μm to 175 μm, and the distance L2 between the reinforcing wall portion 44 and one end portion of the resistance flow path 341 on an ink supply side is 200 μm or more, and thus it is possible to reinforce the flow path substrate while maintaining the performance.

Next, the position of the second reinforcing wall portion 45 of the flow path substrate 402 on a side opposite to the pressure chamber 31 with respect to the resistance flow path 34 is illustrated in FIGS. 13 and 14. Since the reinforcing wall portion 45 is also provided in the same substrate 402, the thickness thereof is the same as the height of the resistance flow paths 341 and 342. FIG. 14 illustrates a relationship between a distance L3 (FIG. 13) between the other end portion of the resistance flow path 34 and one end portion of the reinforcing wall portion 45 on the resistance flow path 34 side and the variation in droplet speed and volume between the pressure chambers 31 (channels). According to FIG. 14, it can be seen that the distance between the reinforcing wall portion 45 and the resistance flow path 341 is preferably appropriately separated, and when the distance is about 200 μm, the variation between the channels is reduced.

For example, in the present embodiment, the openings 4021, 4022, and 4023 are disposed to overlap at least a part of the openings 4011 and 4012 of the other flow path substrate 401, and communicate with the openings 4011 and 4012.

In the flow path member 40, the plurality of pressure chambers 31 are formed by the first openings 4011 and 4021 in the plurality of flow path substrates 401 and 402 that communicate with one another and are arranged in the stacking direction. The plurality of pressure chambers 31 are spaces formed on one side of the vibration region 301 of the vibration plate 30, and each of the pressure chambers 31 communicates with the nozzle 51 formed in the nozzle plate 50. The pressure chambers 31 are closed by the vibration plate 30 on a side opposite to the nozzle plate 50.

The plurality of pressure chambers 31 communicate with the common chambers 321 and 322 via the resistance flow paths 341 and 342 and the common flow path portions 331 and 332. The pressure chamber 31 holds a liquid supplied from the common chambers 321 and 322, and the pressure chamber 31 is deformed by vibration of the vibration plate 30 that forms a part of the pressure chamber 31, thereby ejecting the liquid from the nozzle 51.

In the flow path member 40, the common flow path portions 331 and 332 on both sides of the pressure chamber in the Y direction are formed by the second opening 4012 and the third opening 4023 of the plurality of flow path substrates 401 and 402 aligned in the stacking direction and communicating with each other.

The common flow path portions 331 and 332 are flow paths that communicate with the other end portion of the plurality of resistance flow paths 341 and 342 in a flow direction. The common flow path portions 331 and 332 are formed, for example, between the vibration plate 30 and the nozzle plate 50, and communicate with the common chamber 32 of the manifold 47.

In addition, in the flow path member 40, the resistance flow paths 341 and 342 are formed by a part of the opening 4022 of the flow path substrate 402. The resistance flow paths 341 and 342 communicate with the pressure chambers 31 and the common flow path portions 331 and 332, and extend in the Y direction, which is the flow direction. The resistance flow paths 341 and 342 on both sides are formed to have a smaller dimension in the width direction orthogonal to the extending direction which is the flow direction than the common flow path portions 331 and 332 and the pressure chambers 31, and flow path cross sections of the resistance flow paths 341 and 342 are formed to be narrower than the common flow path portions 331 and 332 and the pressure chambers 31.

Here, each of the flow path substrates 401 and 402 has a structure in which one side and the other side in the Y direction are symmetrical with respect to the nozzle 51. Flow path lengths of the resistance flow paths 341 and 342 arranged at both sides in the Y direction with the central pressure chamber 31 as a center are formed to be equal and flow path cross sections of the resistance flow paths 341 and 342 in a direction orthogonal to the Y direction are formed to have the same shape. In the flow path member 40, the partition wall portions 42 that partition the plurality of pressure chambers 31 are formed by the beam-shaped portions 461 of the stacked flow path substrate 401 and central portions of the beam-shaped portions 462 of the flow path substrate 402.

The partition wall portions 42 are wall-shaped members that partition the plurality of pressure chambers 31 in the arrangement direction. The partition wall portion 42 is disposed in a manner of facing the non-drive piezoelectric element 22 via the vibration plate 30, and is supported by the non-drive piezoelectric element 22. A plurality of the partition wall portions 42 are provided at a pitch the same as an arrangement pitch of the pressure chambers 31.

In the flow path member 40, the side wall portion 43 that separates the plurality of resistance flow paths 341 and 342 from each other is formed by a part of the beam-shaped portion 462 of the flow path substrate 402.

The side wall portion 43 is a wall-shaped member that separates the plurality of resistance flow paths 341 and 342 from each other in the arrangement direction. For example, the side wall portion 43 is provided to communicate with both sides of the pressure chamber 31. The side wall portion 43 is implemented such that a flow path resistance of the resistance flow paths 341 and 342 is larger than that inside the pressure chamber 31 and a flow path cross-sectional area of the resistance flow paths 341 and 342 is smaller than that inside the pressure chamber 31. The plurality of side wall portions 43 are provided at a pitch the same as the arrangement pitch of the plurality of pressure chambers 31.

Here, the inkjet head according to the present embodiment has two head main bodies, and in each of the head main bodies, two actuator portions 20 each including a nozzle row in which the plurality of nozzles 51 are arranged in the X direction and a pressure chamber row in which the plurality of pressure chambers 31 are arranged in the X direction are provided, and in the inkjet head 1, a total of four rows of nozzles 51 and actuator portions 20 are formed.

The common flow path portion 33 includes, for example, the first common flow path portion 331 that communicates with one opening (inlet on a supply side of the pressure chamber 31) of the plurality of pressure chambers 31 formed in the actuator portion 20, and the second common flow path portion 332 that communicates with an opening on a secondary side (outlet on an ejection side of the pressure chamber 31) of the plurality of pressure chambers 31.

That is, the first common flow path portion 331 extending in the X direction is provided on one end side in a second direction (Y direction) to communicate with a plurality of individual flow paths formed of the pressure chamber 31 and the resistance flow paths 341 and 342 and extending in the second direction (Y direction), and the second common flow path portion 332 extending in the X direction is provided on the other end side of the individual flow paths.

The first common flow path portion 331 and the second common flow path portion 332 each communicate with the common chamber 32 in the manifold 47 at both end portions in the first direction. For example, the first common flow path portion 331 and the second common flow path portion 332 are provided with a supply port or an ejection port as a connection port, and are connected to the common chamber 32 in the manifold 47 by the supply port or the ejection port.

The nozzle plate 50 is formed of a metal such as SUS and Ni, or a resin material such as polyimide, and has a rectangular plate shape with a thickness of about 10 μm to 100 μm. The nozzle plate 50 is disposed on one side of the flow path member 40 to cover the opening on one side of the pressure chamber 31. The nozzle plate 50 has a plurality of nozzles 51 that eject liquid droplets. The plurality of nozzles 51 are holes that pass through the nozzle plate 50 in the thickness direction. The plurality of nozzles 51 are arranged in the first direction the same as the arrangement direction of the pressure chambers 31 to form a nozzle row. The nozzles 51 are provided at positions corresponding to the plurality of pressure chambers 31, respectively.

The manifold 47 is a so-called manifold, and is a structure bonded to the vibration plate 30 together with the piezoelectric elements 21 and 22. The manifold 47 is provided on a side of the vibration plate 30 opposite to the flow path member 40. For example, the manifold 47 is adjacent to the actuator portion 20 in the present embodiment. The manifold 47 forms an outer shell of the inkjet head 1. The manifold 47 forms a flow path of the liquid therein.

The common chamber 32 is formed inside the manifold 47. For example, the common chamber 321 on the supply side and the common chamber 322 on the ejection side are formed inside the manifold 47. Each of the common chambers 321 and 322 is provided with a supply port and an ejection port, and is connected to an external supply pipe or ejection pipe, and is connected to a cartridge outside the head via the supply pipe or ejection pipe.

For example, the common chambers 321 and 322 communicate with the pressure chamber 31 via the common flow path portions 331 and 332 and the resistance flow paths 341 and 342 via the supply port and the ejection port.

In the inkjet head 1 implemented as described above, the ink flow path 35 including the plurality of pressure chambers 31 communicating with the plurality of nozzles 51, the plurality of individual liquid chambers 36 each including the resistance flow paths 341 and 342 communicating with the plurality of pressure chambers 31, and a common liquid chamber 37 including the common flow path portions 331 and 332 and the common chambers 321 and 322 formed in the manifold 47 is formed by the nozzle plate 50, the manifold 47, the flow path member 40, and the vibration plate 30. For example, the common chambers 321 and 322 communicate with a cartridge. The ink is supplied to each of the pressure chambers 31 in the flow path member 40 through the common chamber 321, or the ink ejected from the pressure chamber 31 is collected to the cartridge through the common chamber 322.

For example, the resistance flow paths 341 and 342 are disposed on both sides of the pressure chamber 31 in the extending direction, respectively, and a common liquid chamber including the common flow path portion 33 and the common chamber 32 is disposed to be continuous with the other end portion in the extending direction of the resistance flow paths 341 and 342 on both sides.

All of the piezoelectric elements 21 are connected so that a voltage can be applied to wiring. In the inkjet head 1, when the control unit 150 causes a driver IC to apply a drive voltage to the electrodes 221 and 222, the piezoelectric element 21 to be driven vibrates in the stacking direction, that is, the thickness direction of the piezoelectric layers 211. That is, the piezoelectric element 21 vibrates longitudinally.

Specifically, the control unit 150 selectively drives the piezoelectric element 21 to be driven by applying a drive voltage to the internal electrodes 221 and 222 of the piezoelectric element 21 to be driven. Then, the vibration plate 30 is deformed and the volume of the pressure chamber 31 is changed by the piezoelectric element 21 to be driven by combining deformation in a tensile direction and deformation in a compression direction, thereby guiding the liquid from the common chamber 32 and ejecting the liquid from the nozzle 51.

The ink supplied to the pressure chamber 31 is ejected from the nozzle 51, passes through the resistance flow path 342 on the other side serving as a collection side, the second common flow path portion 332, and the common chamber 322 on the ejection side, and is collected in the cartridge. That is, in the inkjet head 1, the ink circulates in the ink flow path 35 with one side in the extending direction as an inflow side (supply side) and the other side as an outflow side (collection side).

The inkjet head 1 according to the present embodiment includes the piezoelectric elements 21 disposed in a manner of facing the pressure chambers 31, and the piezoelectric elements 21 are connected by wiring so that a voltage can be applied thereto. The control unit 150 sends a drive signal to the driver IC according to the image signal corresponding to the image data, and applies a drive voltage to the internal electrodes 221 and 222 of the piezoelectric element 21 to be driven, thereby selectively deforming the piezoelectric element 21 to be driven. The liquid is ejected by changing the volume of the pressure chamber 31 by combining the deformation of the vibration plate 30 in the tensile direction and the deformation of the vibration plate 30 in the compression direction.

For example, the control unit 150 alternately performs a pulling operation and a compressing operation. In the inkjet head 1, at the time of pulling for increasing an internal volume of the target pressure chamber 31, the piezoelectric element 21 to be driven is contracted, and a drive piezoelectric element other than a drive target is not deformed. In the inkjet head 1, at the time of compressing for reducing the internal volume of the target pressure chamber 31, the target drive piezoelectric element 21 is extended and the non-drive piezoelectric element 22 is not deformed.

According to the inkjet head 1 according to the above-described embodiment, the reinforcing wall portion 44 of the flow path substrate 402 is provided in the pressure chamber 31, and the distance L1 from the edge of the nozzle 51 to the position of the reinforcing wall portion 44 is set to 75 μm to 175 μm, so that AL is stabilized, variations in the ejection speed and the ejection volume between the pressure chambers (channels) are reduced, and the flow path substrate can be reinforced while maintaining the ejection performance.

In addition, by setting the distance L2 between the reinforcing wall portion 44 and one end portion of the resistance flow path 34 on the pressure chamber side to 200 μm to 300 μm, variations in the ejection speed and the droplet volume between the pressure chambers 31 (channels) are reduced.

In addition, by reinforcing the substrate 402 defining the elongated resistance flow paths 341 and 342 having a small thickness, the accuracy of a width dimension of the flow path can be improved, and the ejection performance can also be improved.

The present disclosure is not limited to the embodiment described above, and the elements described above can be modified and embodied in an implementation stage without departing from the gist of the disclosure.

For example, the present disclosure is not limited to the form in which the reinforcing wall portions 44 and 45 are formed, and can be appropriately changed. For example, only the reinforcing wall portion 44 in the pressure chamber may be provided, or a reinforcing wall portion may be further provided at another position.

The shape of each flow path substrate is not limited to the above embodiment. For example, the flow path member 40 is formed of two flow path substrates 401 and 402 in the above embodiment, but three or more flow path substrates may be used. In addition, shapes of openings in the flow path substrates 401 and 402 are not limited to those in the above-described embodiment. For example, in the above-described embodiment, the first flow path substrate 401 is formed of a thick plate and the second flow path substrate 402 is formed of a thin plate, but embodiments of this disclosure are not limited thereto, and the first flow path substrate 401 may be formed by stacking a plurality of plate members. For example, the flow path member 40 may be formed using three substrates having the same thickness. Also in this case, since the substrate having no wall portion constituting a periphery of the resistance flow paths 341 and 342 particularly determining the resistance and having the openings to be the resistance flow paths 341 and 342 formed therein has a particularly long opening, it is effective to form the reinforcing wall portions 44 and 45.

In addition, positions of the first flow path substrate 401 and the second flow path substrate 402 in the stacking direction are not limited to the above-described embodiment, and can be changed as appropriate. For example, the flow path substrate 401 as the first flow path substrate may be on a side close to the nozzle plate 50, and the flow path substrate 402 as the second flow path substrate may be on a side close to the actuator portion 20.

For example, the piezoelectric element 21 formed by stacking a plurality of piezoelectric members is driven by longitudinal vibration (d33) in the stacking direction in the above-described embodiment, embodiments of this disclosure are not limited thereto. For example, the piezoelectric element 21 may be applicable to an aspect of being formed of a single-layer piezoelectric member, and may be applicable to an aspect of being driven by lateral vibration (d31).

The liquid to be ejected is not limited to ink for printing, and for example, the embodiment described herein may be applied to an apparatus that ejects a liquid containing conductive particles for forming a wiring pattern of a printed wiring board.

Although the inkjet head 1 is used in a liquid ejection apparatus such as an inkjet recording apparatus in the embodiment described above, embodiments of this disclosure are not limited thereto. For example, the inkjet head 1 may be used in a 3D printer, an industrial manufacturing machine, and a medical application, and the inkjet head 1 can be reduced in size, weight, and cost.

According to at least one embodiment described above, a desired flow path shape can be easily set.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head comprising:
a nozzle plate extending in a first direction and having a nozzle for ejecting a liquid; and
a plurality of flow path substrates extending in the first direction and each having an opening or a groove by which a pressure chamber communicating with the nozzle and a resistance flow path communicating with the pressure chamber are formed, wherein
at least one of the flow path substrates includes a first reinforcing wall portion at a location at which the pressure chamber is formed, and
in the first direction, a distance between one end of the first reinforcing wall portion that is closer to the nozzle than the other end and an edge of the nozzle that is closest to the one end of the first reinforcing wall portion is 75 μm to 175 μm.

2. The liquid ejection head according to claim 1, wherein
the first reinforcing wall portion faces an opening or a groove of another flow path substrate, and
in the first direction, a distance between a boundary of the resistance flow path and the pressure chamber and the other end of the first reinforcing wall portion is 200 μm to 300 μm.

3. The liquid ejection head according to claim 1, wherein
the resistance flow path is narrower than the pressure chamber.

4. The liquid ejection head according to claim 1, wherein
said at least one of the flow path substrates further includes a second reinforcing wall portion such that the resistance flow path is between the first and second reinforcing wall portions, and
in the first direction, a distance between one end of the second reinforcing wall portion that is closer to the first reinforcing wall portion and one end of the resistance flow path that is farther from the first reinforcing wall portion is 200 μm or more.

5. The liquid ejection head according to claim 1, wherein
the plurality of flow path substrates includes a first flow path substrate including the first reinforcing wall portion and a second flow path substrate that is stacked on the first flow path substrate and thicker than the first flow path substrate.

6. The liquid ejection head according to claim 5, wherein
the second flow path substrate includes a plurality of first openings, one of which forms a part of the pressure chamber, the first openings being separated from one another by a plurality of first beam-shaped portions.

7. The liquid ejection head according to claim 6, wherein
the second flow path substrate further includes at least one second opening that forms a common flow path.

8. The liquid ejection head according to claim 7, wherein
said at least one second opening of the second flow path substrate is wider than each of the first openings of the second flow path substrate in a second direction orthogonal to the first direction.

9. The liquid ejection head according to claim 5, wherein
the first flow path substrate includes:
a plurality of first openings, one of which forms a part of the pressure chamber, and
a plurality of second openings, one of which forms a part of the resistance flow path.

10. The liquid ejection head according to claim 9, wherein
the first and second openings are separated by a plurality of second beam-shaped portions, and
the first reinforcing wall portion connects the plurality of second beam-shaped portions.

11. The liquid ejection head according to claim 9, wherein
the first flow path substrate further includes at least one third opening that forms a common flow path.

12. The liquid ejection head according to claim 5, wherein
in a stacking direction of the first and second flow path substrates, a thickness of the first reinforcing wall portion is the same as a thickness of the first flow path substrate.

13. The liquid ejection head according to claim 1, wherein
the plurality of flow path substrates includes first and second flow path substrates,
the first flow path substrate including a plurality of first openings, a plurality of second openings, and at least one third opening, and
the second flow path substrate including a plurality of first openings and at least one second opening, and
the pressure chamber is formed by the plurality of first openings of the first flow path substrate and the plurality of first openings of the second flow path substrate overlapping each other.

14. The liquid ejection head according to claim 13, wherein
a common flow path is formed by said at least one third opening of the first flow path substrate and said at least one second opening of the second flow path substrate overlapping each other.

15. The liquid ejection head according to claim 13, wherein
the resistance flow path is formed by the plurality of second openings of the first flow path substrate.
